(19) United States
(12) Patent Application Publication
(10) Pub. No.: US 2009/0322738 A1
(43) Pub. Date: Dec. 31, 2009

(54) METHODS AND APPARATUS FOR DISPLAYING IMAGES USING HOLOGRAMS

(75) Inventor: Adrian Cable, Cambridgeshire (GB)

Correspondence Address: KNOBBE MARTENS OLSON & BEAR LLP, 2040 MAIN STREET, FOURTEENTH FLOOR, IRVINE, CA, 92614, US

(73) Assignee: Light Blue Optics Ltd., Cambridgeshire (GB)

(21) Appl. No.: 12/161,955

(22) PCT Filed: Jan. 24, 2007
(86) PCT No.: PCT/GB2007/050037

§ 371 Date: Feb. 19, 2009

(30) Foreign Application Priority Data
Jan. 25, 2006 (GB) 0601481.5

(51) Int. Cl. G06T 15/00

(52) U.S. Cl. 345/419

(57) ABSTRACT

We describe a method of generating data for displaying an image defined by a plurality of holographically generated subframes for display sequentially in time to give the impression of said image, the method including: receiving data for said image for display; determining holographic data for a said subframe from target image data at a first spatial resolution derived from said received data; converting said holographic data to image subframe data for display to generate a said holographic subframe, said image subframe data having a second spatial resolution lower than said first spatial resolution; generating reconstructed image data at said first spatial resolution from said image subframe data, said reconstructed image data representing said displayed holographic subframe; adjusting said target image data using said reconstructed image data; and determining holographic data and image subframe data for a subsequent said subframe using said adjusted image data.

This invention generally relates to techniques for displaying an image using a plurality of holographically generated subframes. More particularly the invention is concerned with methods, apparatus and computer program code for enhancing the effective resolution of images displayed in this way.

We have previously described techniques for displaying an image (which here includes a frame of a video sequence) by successively displaying holographic subframes. Although each subframe in itself, may be of relatively low perceived image quality, these integrate within the human eye to give the impression of a high quality image. By way of background we provide an outline of our preferred technique, referred to as OSPR (One Step Phase Retrieval) later; for more details reference may also be made to our co-pending patent applications, for example, WO 2005/059881 (hereby incorporated by reference). Broadly speaking the succession of holographic subframes is displayed using a spatial light modulator (SLM) such as one of a range of available so-called micro displays. The SLM is modulated with holographic data for each subframe which, in some preferred embodiments, is binary (either on or off) as a result of quantising the subframe data into two (or more) phases. This facilitates the use of a relatively inexpensive SLM and also significantly reduces the quantisation requirements. In some other preferred embodiments more than two phase levels are employed, for example four phase modulation (0, π/2, π, 3 π/2) since with only binary modulation a conjugate image is produced and the displayed image comprises a pair of images, one spatially inverted with respect to the other, losing half the available light. This can be avoided with four phase modulation (it will be understood that an SLM will, in general, provide phase rather than amplitude modulation); again for further details reference may be made to WO'881 (ibid). We have further previously described some improved techniques for noise reduction, in particular in UK Patent Application No. GB 0518912.1 filed on 16 Dec. 2005 (incorporated by reference) in which, broadly speaking, each successive subframe is adjusted to compensate for noise generated by one or more previously displayed subframes. This improves the convergence of the procedure (1/N² rather than 1/N, where N is the number of subframes) thus again reducing the computational load and/or increasing the perceived image quality.

However there remains a general need for increasing the quality of the displayed image and/or decreasing the computational load. It has previously been recognised that when displaying an image using a single computer generated hologram, if it were possible to adjust the phase distribution of the computer generated hologram in just the right way an increase in resolution might be achieved (see Yasuhiro Takaki and Junichi Hojo, Computer-generated holograms to produce high-density intensity patterns, Applied Optics, Vol. 38 (11) pp. 2189-2195) although it was not known how this could be done (see section 5, discussion, ibid). The problem can be illustrated as follows: in a holographically displayed image each “point” of the image is expressed using a pattern of light which is the Fourier transform of the SLM aperture (generally a two-dimensional sinc² function). Depending upon the pixel pattern and holographic data, two adjacent pixels may either be represented by a +1, +1 pattern or by a +1, −1 pattern. In the former case constructive interference occurs and the two pixels effectively merge; in the latter case the two pixels destructively interfere at the boundary between the two creating a black image which is visually distracting and manifests itself as speckle in the displayed image. Thus one expression of the problem is to find a way of reducing this speckle, in particular in the context of a system which displays an image using a plurality of holographic subframes. The inventors have recognised that in such a system the right choice of phase can effectively be made without having to explicitly calculate what the phase should be, by averaging over multiple subframes. Thus, broadly speaking, the inventors have recognised that by working at different resolutions the effect of speckle at the interfaces between adjacent pixels which is generally problematic can be exploited for the purpose of resolution enhancement. Further, in the context of an OSPR-type procedure which involves a phase randomisation step (to convert an input image spatial frequency spectrum which generally tails off towards the high frequencies to a substantially flat spectrum) embodiments of the technique allow an increase in effective resolution (and a reduction in speckle) whilst meeting the desirable requirement of a substantially flat spatial frequency spectrum.

According to a first aspect of the present invention there is therefore provided a method of generating data for displaying an image defined by a plurality of holographically generated subframes for display sequentially in time to give the impression of said image, the method comprising: receiving data for said image for display; determining holographic data for a said subframe from target image data at a first spatial resolution derived from said received data; converting said holographic data to image subframe data for display to generate a said holographic subframe, said image subframe data having a second spatial resolution lower than said first spatial resolution; generating reconstructed image data at said first spatial resolution from said image subframe data, said reconstructed image data representing said displayed holographic subframe; adjusting said target image data using said reconstructed image data; and determining holographic data and image subframe data for a subsequent said subframe using said adjusted image data.

Broadly speaking, in embodiments by determining the holographic subframe data at a higher resolution than is actually used to display a subframe, compensation for phase-induced errors can be formed automatically by adjusting the target image data, in particular target phase data (for pixels of the image) to compensate for the errors introduced. Preferably this is performed so that the flat spatial spectrum constraint is satisfied.

In embodiments the target phase data (for pixels of the target image) is initially randomised but afterwards adjusted to perform error compensation and hence noise reduction, the error compensation being performed at a higher resolution than a displayed subframe, in this way effectively increasing the resolution of the displayed image. Preferably the compensation is performed iteratively, for each successively displayed subframe, each subframe thus compensating for cumulative phase-related errors resulting from previous holographic subframes for the image. Further preferably a second compensation loop is included when determining the data for each subframe in accordance with the target image data. Thus preferably determining the holographic data for a subframe includes adjusting the target phase data in response to the calculated image subframe data, to produce successively improved approximations to the desired target. This process may be viewed as a loop in which the amplitude data of a target data image is fixed (by the target) but in which the phase data is effectively a free parameter. The data for displaying a subframe is initially calculated from the target phase data but this is then used to reconstruct the displayed subframe and adjust the target phase data so that on a further iteration the image subframe data is a better approximation to the desired subframe image. A predetermined number of iterations may be employed to converge on the desired target. In embodiments this “inner” loop involves Fourier and inverse Fourier transforms and phase quantisation (for example binarisation) since these conserve the substantially flat spectrum provided by the initial randomisation; other types of transform may, however, also be employed. Thus broadly speaking in embodiments the initial randomisation of the image plane phase results in a roughly flat spectrum—i.e. the spectrum (hologram) approximates a phase-only function, and this constraint is subsequently enforced in the hologram plane at each iteration by the phase quantisation operation.

In some preferred embodiments converting the holographic data to the image subframe data for, for example, driving a spatial light modulator comprises band limiting the holographic data. This may be implemented, for example, by selectively masking out the higher frequency components of the holographic data which comprise those further out from the origin of the holographic (spatial frequency) plane. For example a square or rectangular mask centred at the centre of the spatial frequency plane may be applied.

In preferred embodiments generation of the reconstructed image data includes a transformation from the frequency domain back to the spatial domain, the transformation being configured to provide an increase in resolution back to the first level of resolution. This may be implemented, for example, by padding the holographic subframe data with predetermined data, particularly zeros, to add high spatial frequency components so that the resolution corresponds to the first resolution; then a conventional transform such as a Fourier or inverse Fourier transform may be employed. Alternatively a modified Fourier or other transform may be employed in which the transform is applied at points interpolated between the input (frequency domain) subframe points to increase the x and or y resolution by a factor of two or more. (The skilled person will understand that in this context Fourier and inverse Fourier transforms are equivalent, apart from a scaling factor).

In preferred embodiments the generation of the reconstructed image data also includes converting the (complex) spatial domain output from the transformation into magnitude value data, to approximate what an observer's eye would see.

In another, related aspect the invention provides a method of generating data for displaying an image using a plurality of holographically generated temporal image subframes, the method comprising: receiving data for said image to be displayed and determining target image data from said received data; performing a space-frequency transform at a first resolution on said target image data to generate data for a said image subframe; and reducing said first resolution to generate data for displaying a said subframe.

As noted above, in preferred embodiments the target image data includes phase data and the method further comprises adjusting a phase of the target image data for a subframe to compensate for phase-related noise in the subframe. In embodiments this provides an iterative subframe data generation process in which the phase (prior to quantisation, for example binarisation or four phase quantisation) converges on a set of values (for the pixels) which give the optimum perceived result from the resolution reduction process. Preferably the method also includes adjusting the phase data of the target image data for a subframe to compensate for phase-related noise in one or more subframes. This provides an iterative process in which each successive subframe aims to optimise the effect of the resolution reduction on the displayed image from the previous frames. As mentioned above, preferably the adjusting of the phase data of the target image comprises performing a frequency-space transform of the data for a displayed subframe which includes an increase in resolution back to the higher resolution used for generating the image subframe.

The invention further provides a method of generating data for displaying an image defined by displayed image data using a plurality of holographically generated temporal subframes, said temporal subframes being displayed sequentially in time such that they are perceived as a single noise-reduced image, the method comprising generating from said displayed image data holographic data for each subframe of said set of subframes such that successive replay of holograms defined by said holographic data for said subframes gives the appearance of said image, a said subframe having a reduced resolution compared to a resolution of said image data, and wherein the method further comprises, when generating said holographic data for a said subframe, compensating for said resolution reduction arising from one or more previous subframes of said sequence of holographically generated subframes.

The invention further provides processor control code to implement the above-described methods, in particular on a data carrier such as a disk, CD- or DVD-ROM, programmed memory such as read-only memory (Firmware), or on a data carrier such as an optical or electrical signal carrier. Code (and/or data) to implement embodiments of the invention may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog (Trade Mark) or VHDL (Very high speed integrated circuit Hardware Description Language). As the skilled person will appreciate such code and/or data may be distributed between a plurality of coupled components in communication with one another.

In a first complementary aspect the invention provides a system for generating data for displaying an image defined by a plurality of holographically generated subframes for display sequentially in time to give the impression of said image, the system comprising: an input to receive data for said image for display; working memory; a holographic subframe output; program memory storing processor control code; and a processor coupled to said program memory, data memory input, and output, to load and implement said processor control code, said code comprising code for controlling the processor to: determine holographic data for a said subframe from target image data at a first spatial resolution derived from said received data; convert said holographic data to image subframe data for display to generate a said holographic subframe, said image subframe data having a second spatial resolution lower than said first spatial resolution; generate reconstructed image data at said first spatial resolution from said image subframe data, said reconstructed image data representing said displayed holographic subframe; adjust said target image data using said reconstructed image data; and determine holographic data and image subframe data for a subsequent said subframe using said adjusted image data.

The invention further provides a system for generating data for displaying an image using a plurality of holographically generated temporal image subframes, the system comprising: an input to receive data for said image to be displayed; working memory; a holographic subframe output; program memory storing processor control code; and a processor coupled to said program memory, data memory input, and output, to load and implement said processor control code, said code comprising code for controlling the processor to: determine target image data from said received data; perform a space-frequency transform at a first resolution on said target image data to generate data for a said image subframe; and reduce said first resolution to generate data for displaying a said subframe.

The invention still further provides a system for displaying an image defined by displayed image data using a plurality of holographically generated temporal subframes, said temporal subframes being displayed sequentially in time such that they are perceived as a single-noise reduced image, the system comprising: an input for said displayed image data; working memory for storing said displayed image data and said holographic subframe data; a holographic subframe data output; program memory storing processor control code; and a processor coupled to said memory, data memory, input, and output, to load and implement said processor control code, said code comprising code for controlling the processor to: generate from said displayed image data holographic data for each subframe of said set of subframes such that successive replay of holograms defined by said holographic data for said subframes gives the appearance of said image, a said subframe having a reduced resolution compared to a resolution of said image data; and, when generating said holographic data for a said subframe, compensate for said resolution reduction arising from one or more previous subframes of said sequence of holographically generated subframes.

In still further aspects the invention provides a system, for each of the above described method aspects of the invention, and for their embodiments. Each system therefore comprises means for implementing each of the steps of the respective above described methods.

These and other aspects of the invention will now be further described, by way of example only, with reference to the accompanying figures in which:

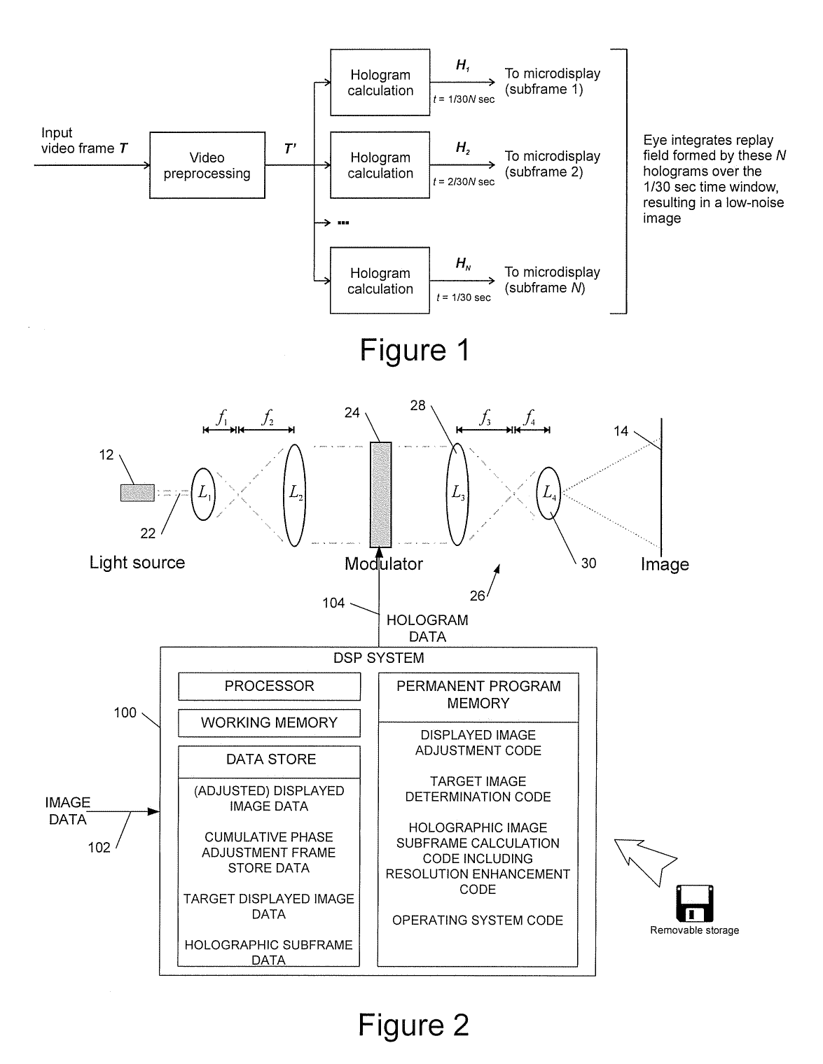

FIG. 1 shows a system for generating a plurality (N) of subframe holograms for displaying a single image frame;

FIG. 2 shows an example of a holographic projection system embodying aspects of the present invention;

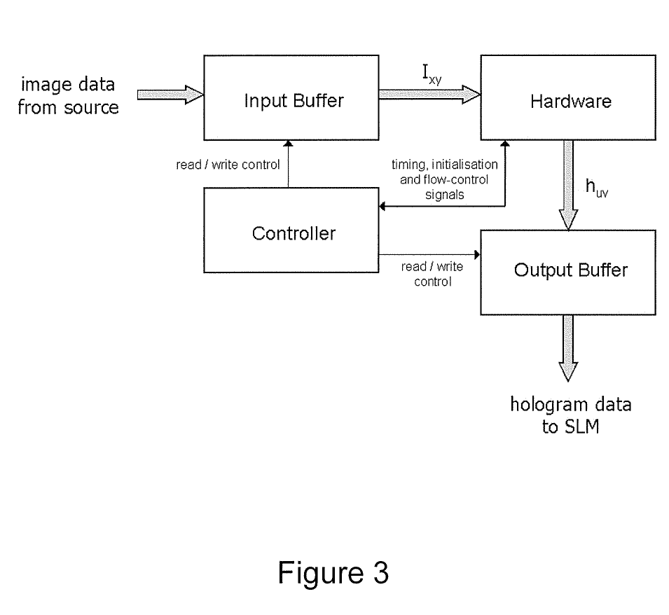

FIG. 3 shows a block diagram of hardware for implementing an OSPR procedure;

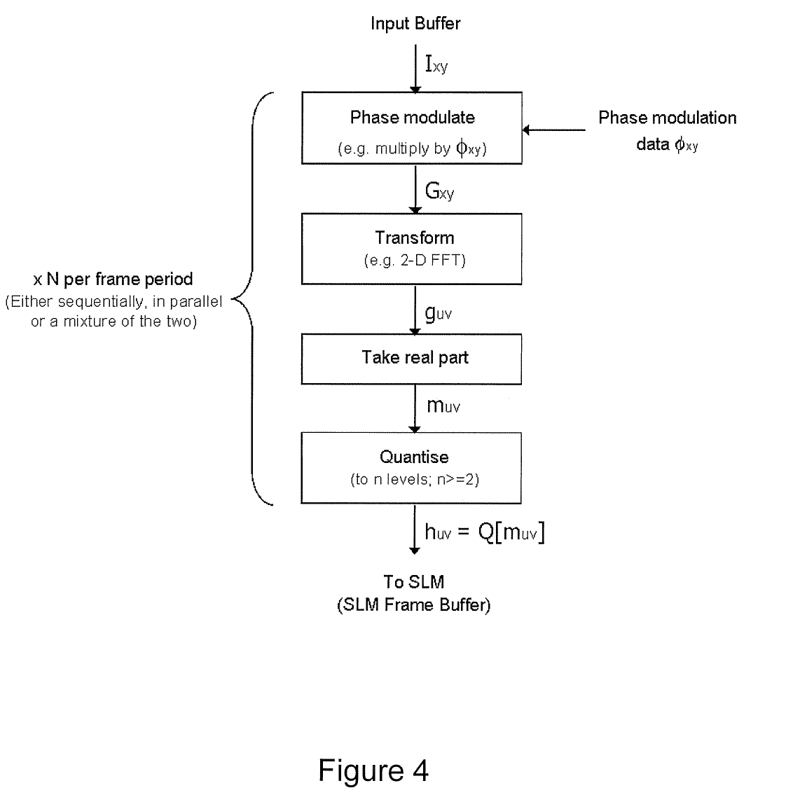

FIG. 4 shows the operations performed in an implementation of an OSPR procedure;

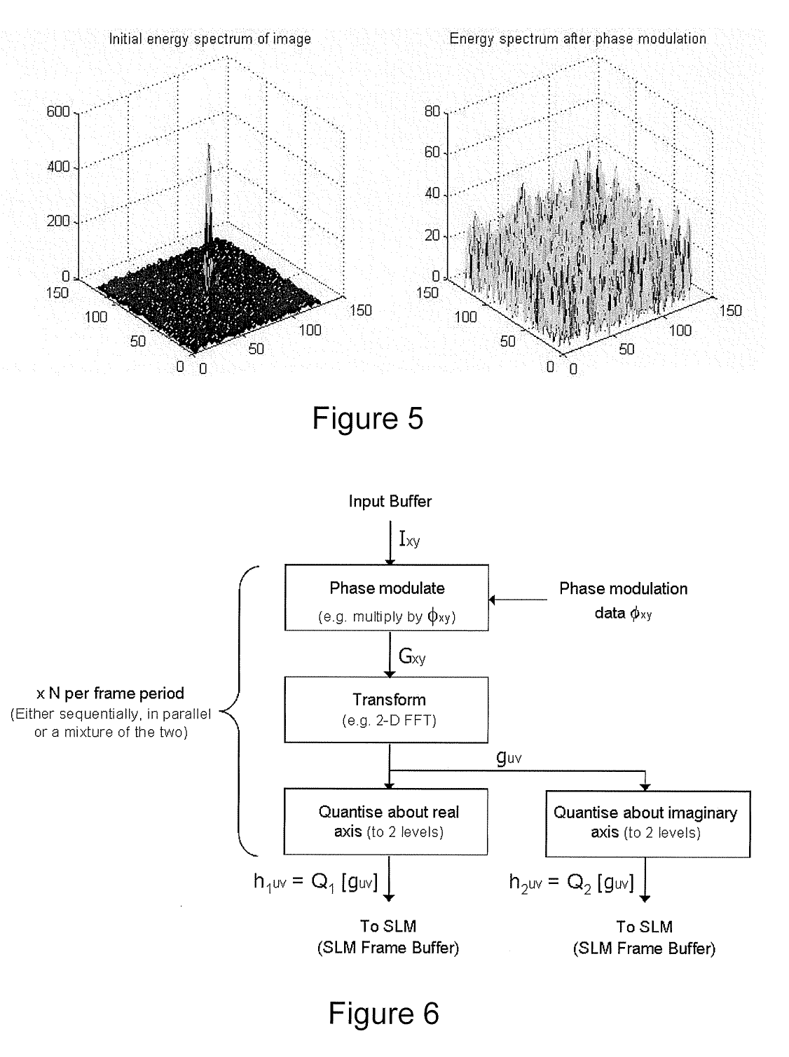

FIG. 5 shows the energy spectra of a sample image before and after multiplication by a random phase matrix;

FIG. 6 shows parallel quantisers for the simultaneous generation of two sub-frames from real and imaginary components of complex holographic sub-frame data respectively;

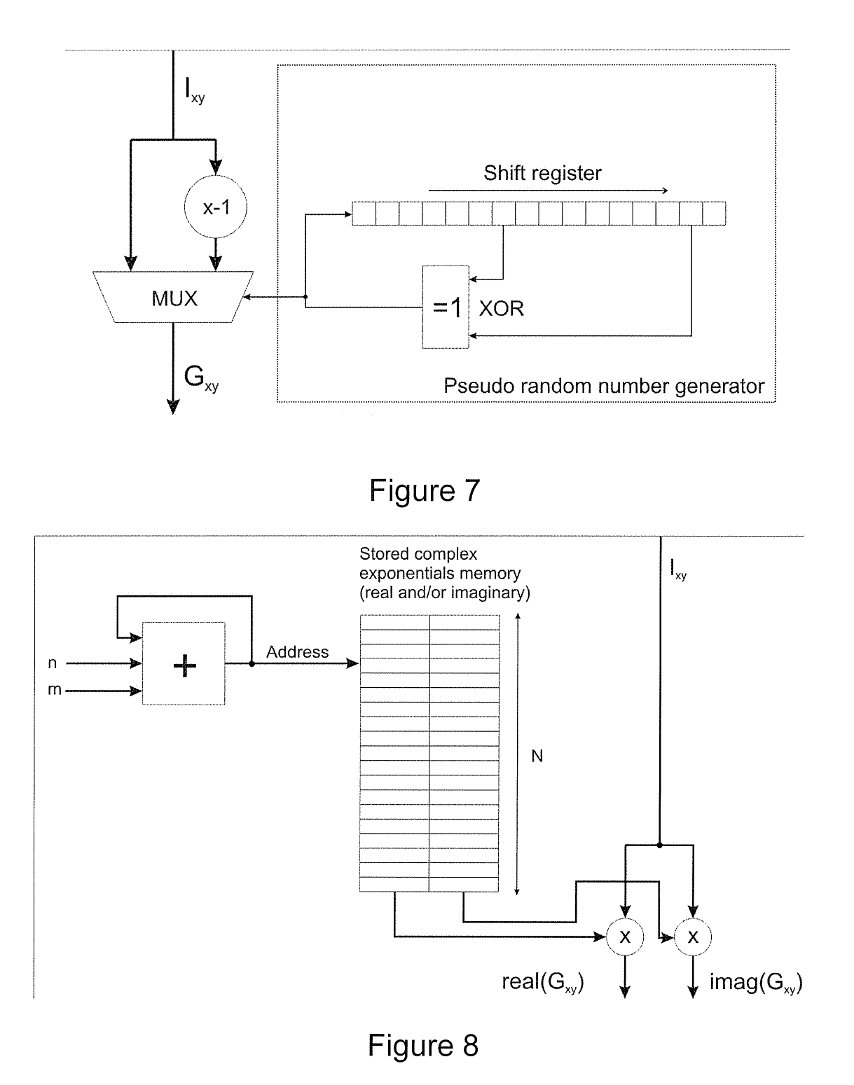

FIG. 7 shows hardware to generate pseudo-random binary phase data and multiply incoming image data, I_{xy}, by the phase values to produce G_{xy}.

FIG. 8 shows hardware to multiply incoming image frame data, I_{xy}, by complex phase values, which are randomly selected from a look-up table, to produce phase-modulated image data, G_{xy};

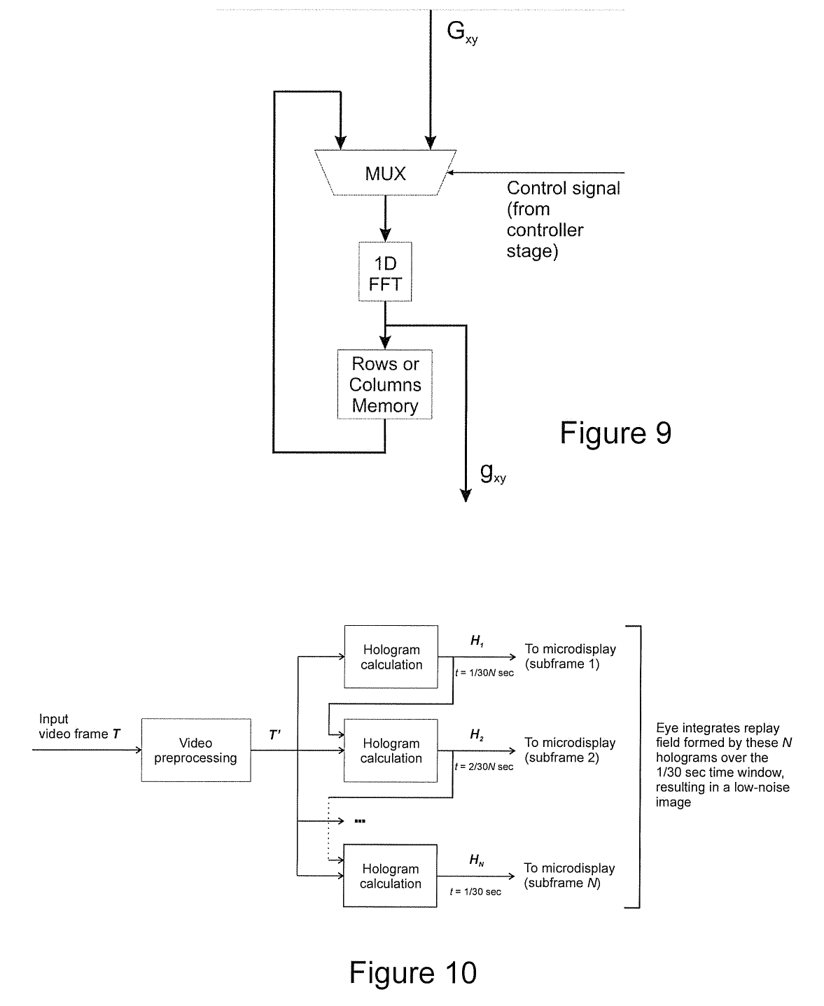

FIG. 9 shows hardware to perform a 2-D FFT on incoming phase-modulated image data, G_{xy} by means of a 1-D FFT block with feedback, to produce holographic data gᵤᵥ;

FIG. 10 shows an outline block diagram of a system according to an embodiment of the invention for generating a plurality (N) of subframe holograms for displaying a resolution-enhanced image;

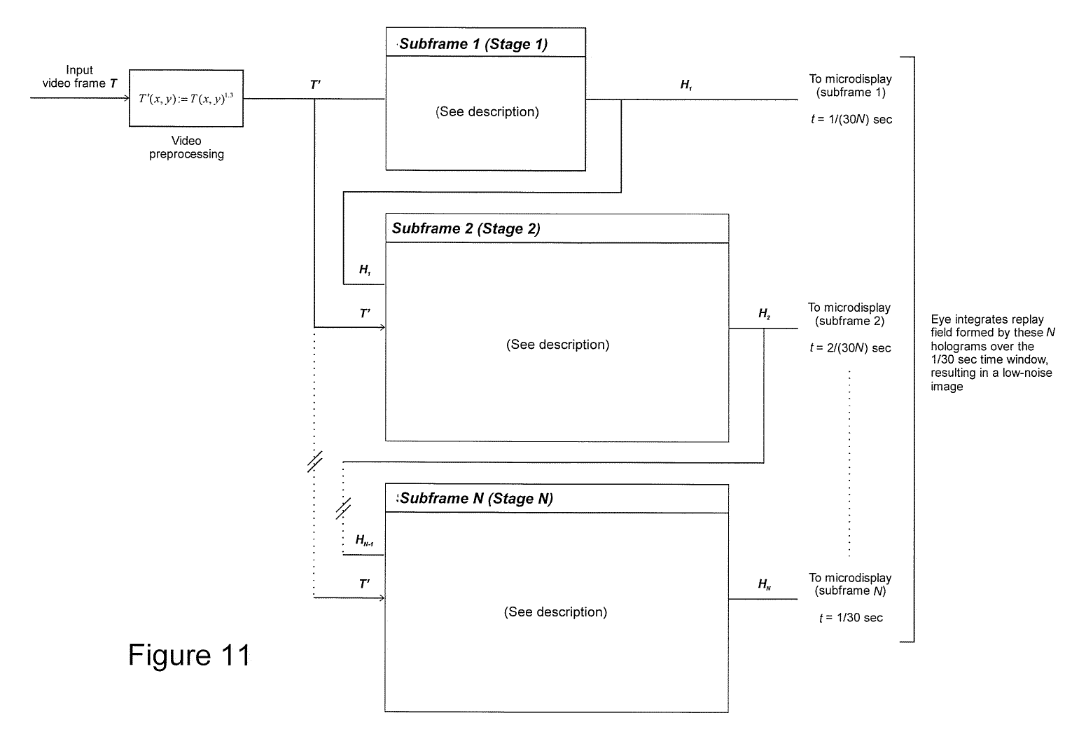

FIG. 11 shows a procedure according to an embodiment of the invention for generating a plurality (N) of subframe holograms for displaying an enhanced perceived resolution image;

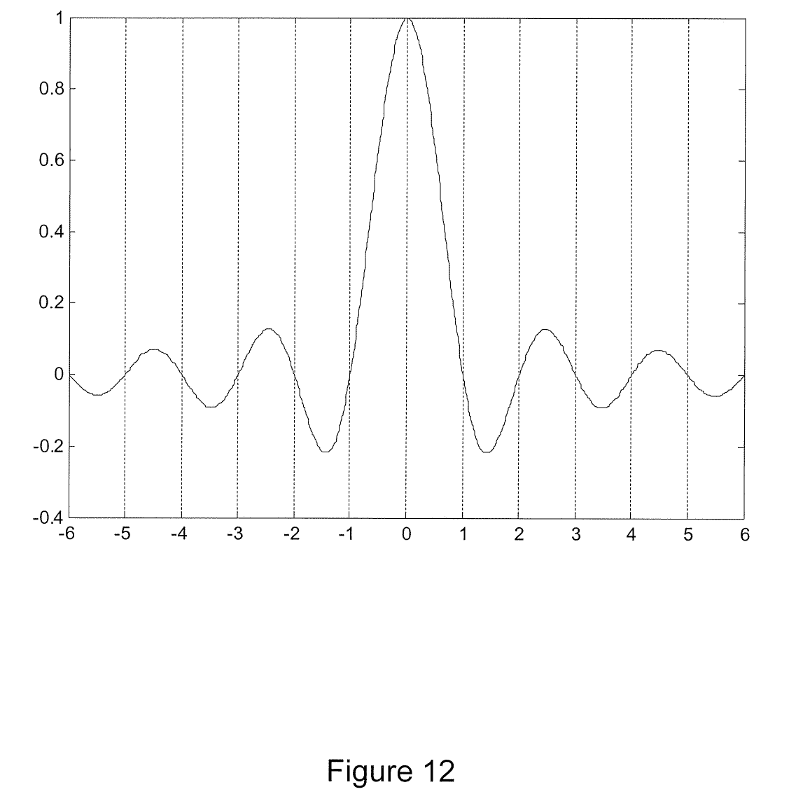

FIG. 12 shows a typical output field “pixel” formed by a square hologram;

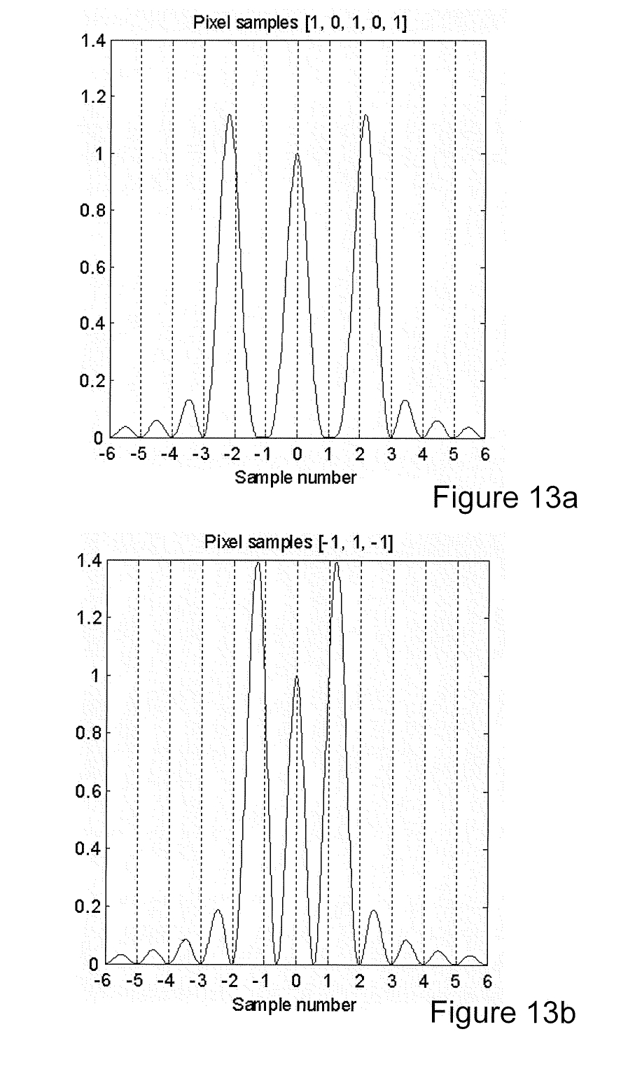

FIGS. 13a and 13b show illustrations of controlling pixel phase to produce a super-resolution effect;

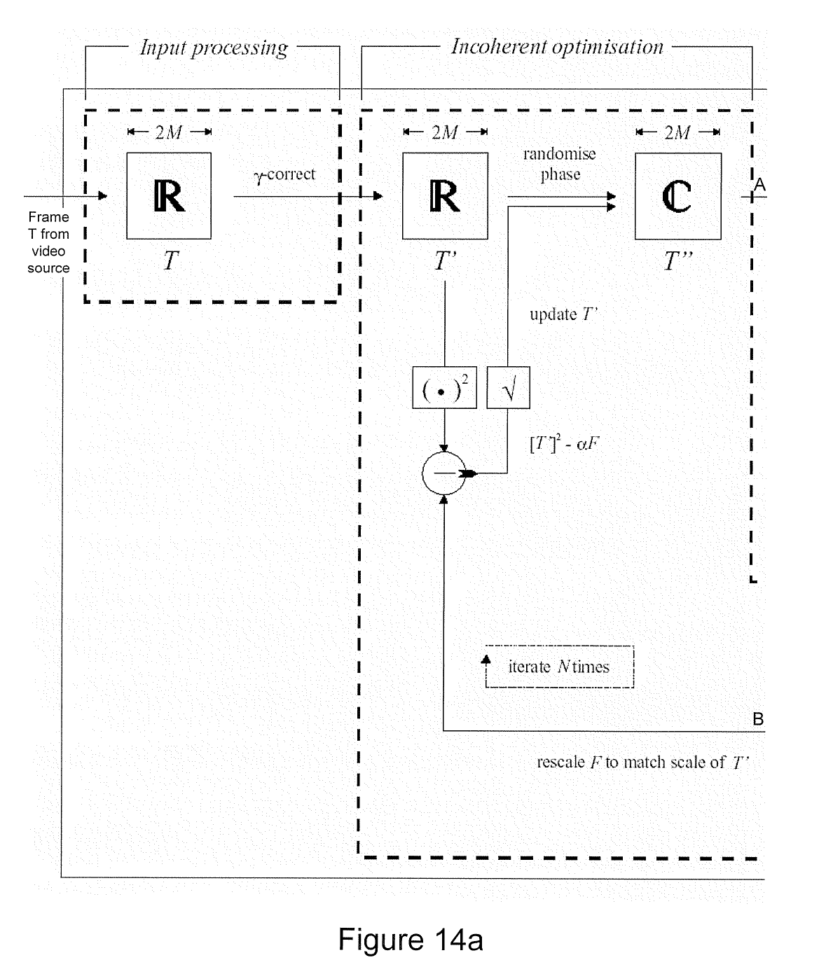

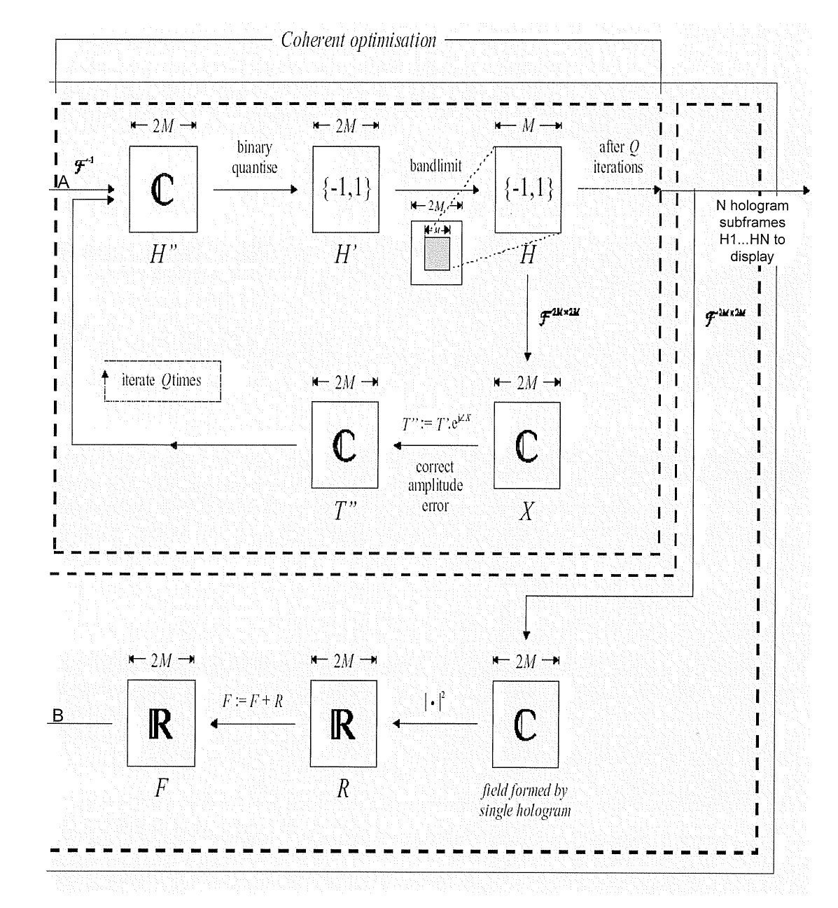

FIGS. 14a and 14b show a detailed block diagram of a system according to an embodiment of the invention for generating a plurality (N) of subframe holograms for displaying a resolution-enhanced image;

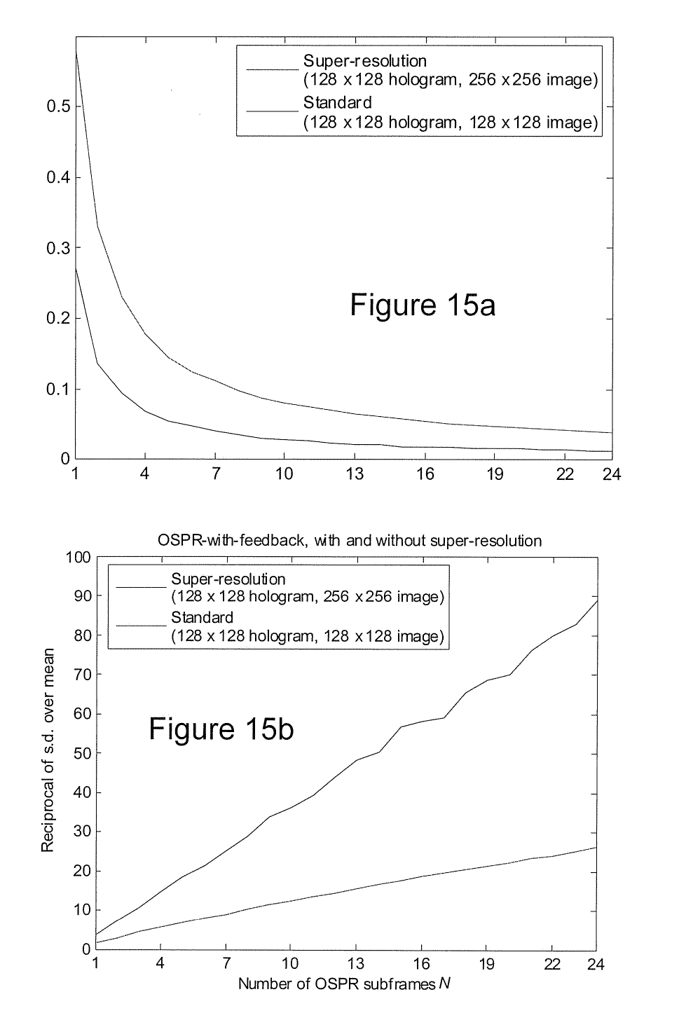

FIGS. 15a and 15b show variations of standard deviation over mean statistic (FIG. 15a) and its reciprocal (FIG. 15b) with N, for OSPR-with-feedback with (upper trace in FIG. 15a, lower trace in FIG. 15b) and without super-resolution; and

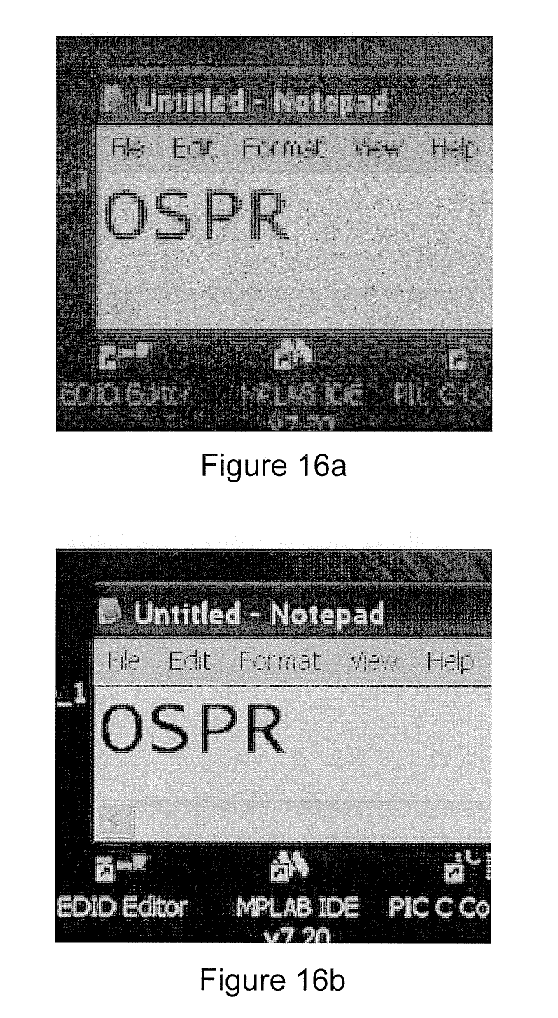

FIGS. 16a and 16b show a comparison of conventional OSPR-with-feedback (FIG. 16a) and super-resolution OSPR-with-feedback (FIG. 16b).

### OSPR (ONE-STEP PHASE RETRIEVAL)

Referring first to FIG. 1, this outlines an OSPR (One-Step Phase Retrieval) process which, instead of generating a single hologram for each video or image frame (at 30 Hz, for example), generates a number N of “subframe holograms” for each video (or image) frame, which are displayed sequentially within the time period of a single frame (in this example, 1/30 of a second). It can be shown that, if each of these subframe holograms forms the same image but with different (and independent) noise, the limited temporal bandwidth of the eye results in an averaging effect (integration with the eye), causing a substantial decrease in the perceived level of noise. More precisely, noise variance, which correlates strongly with the perceptual level of noise present, can be shown to fall as 1/N.

It is helpful, as a preliminary, to describe the basic (non-adaptive) OSPR algorithm and its implementation. The algorithm is a method of generating, for each still or video frame I=I_{xy}, sets of N binary-phase holograms h⁽¹⁾ . . . h^{(N)}. Statistical analysis of the algorithm has shown that such sets of holograms form replay fields that exhibit mutually independent additive noise.

$$1. Let {G}_{xy}^{( n )} = {I}_{xy} exp ( {jϕ}_{xy}^{( n )} ) where {ϕ}_{xy}^{( n )} is uniformly distributed between$$

$$0 and 2 π for 1 \leq n \leq N / 2 and 1 \leq x , y \leq m$$

$$2. Let {g}_{uv}^{( n )} = {F}^{- 1} [ {G}_{xt}^{( n )} ] where {F}^{- 1} represents the two \text{-} dimensional$$

$$inverse Fourier transform operator , for 1 \leq n \leq N / 2$$

$$3. Let {m}_{uv}^{( n )} = \{ {g}_{uv}^{( n )} \} for 1 \leq n \leq N / 2$$

$$4. Let {m}_{uv}^{( n + N / 2 )} = \{ {g}_{uv}^{n} \} for 1 \leq n \leq N / 2$$

$$5. Let {h}_{uv}^{( n )} = \{ \begin{matrix}- 1 & if {m}_{uv}^{( n )} < {Q}^{( n )} \\ 1 & if {m}_{uv}^{( n )} \geq {Q}^{( n )}\end{matrix} where {Q}^{( n )} = median ( {m}_{uv}^{( n )} ) \\ and 1 \leq n \leq N$$

Step 1 forms N targets G_{xy}⁽ⁿ⁾ equal to the amplitude of the supplied intensity target I_{xy}, but with independent identically-distributed (i.i.t.), uniformly-random phase. Step 2 computes the N corresponding full complex Fourier transform holograms gᵤᵥ⁽ⁿ⁾. Steps 3 and 4 compute the real part and imaginary part of the holograms, respectively. Binarisation of each of the real and imaginary parts of the holograms is then performed in step 5: thresholding around the median of mᵤᵥ⁽ⁿ⁾ ensures equal numbers of −1 and 1 points are present in the holograms, achieving DC balance (by definition) and also minimal reconstruction error. In an embodiment, the median value of mᵤᵥ⁽ⁿ⁾ is assumed to be zero. This assumption can be shown to be valid and the effects of making this assumption are minimal with regard to perceived image quality. Further details can be found in the applicant's earlier application (ibid), to which reference may be made.

FIG. 2 shows an example of a holographic projection system suitable for implementing an embodiment of the invention as described further later. Referring to FIG. 2, a laser diode 20 provides substantially collimated light 22 to a spatial light modulator 24 such as a pixellated liquid crystal modulator. The SLM 24 phase modulates lights 22 and the phase modulated light is provided a demagnifying optical system 26. In the illustrated embodiment, optical system 26 comprises a pair of lenses 28, 30 with respective focal lengths f₁, f₂, f₁<f₂, spaced apart at distance f₁+f₂. Optical system 26 increases the size of the projected holographic image by diverging the light forming the displayed image, as shown.

Lenses L₁ and L₂ (with focal lengths f₁ and f₂ respectively) form the beam-expansion pair. This expands the beam from the light source so that it covers the whole surface of the modulator. Lens pair L₃ and L₄ (with focal lengths f₃ and f₄ respectively) form the beam-expansion pair. This effectively reduces the pixel size of the modulator, thus increasing the diffraction angle. As a result, the image size increases. The increase in image size is equal to the ratio of f₃ to f₄, which are the focal lengths of lenses L₃ and L₄ respectively.

A digital signal processor system 100 has an input 102 to receive image data from the consumer electronic device defining the image to be displayed. The DSP 100 implements a procedure as described herein to generate sub-frame (phase) hologram data for a plurality of holographic sub-frames which is provided from an output 104 of the DSP 100 to the SLM 24, optionally via a driver integrated circuit if needed. The DSP 100 drives SLM 24 to project a plurality of phase hologram sub-frames which combine to give the impression of displayed image 14.

The DSP system 100 comprises a processor coupled to working memory, to data memory storing (adjusted) displayed image data, cumulative phase-adjustment frame store data, target displayed image data, and holographic subframe data and to program memory such as ROM, Flash RAM or other non-volatile memory storing processor control code, in particular displayed image adjustment code, target image determination code, holographic image subframe calculation code including resolution enhancement code, and operating system code to implement corresponding functions as described further later.

FIG. 3 shows an outline block diagram of hardware for a holographic OSPR-based image display system. The input to the system of FIG. 3 is preferably image data from a source such as a computer, although other sources are equally applicable. The input data is temporarily stored in one or more input buffers, with control signals for this process being supplied from one or more controller units within the system. Each input buffer preferably comprises dual-port memory such that data is written into the input buffer and read out from the input buffer simultaneously. The output from the input buffer is an image frame, labelled I, and this becomes the input to a hardware block which performs a series of operations on each of the aforementioned image frames, I, and for each one produces one or more holographic sub-frames, h, which are sent to one or more output buffers. Each output buffer preferably comprises dual-port memory. These sub-frames are outputted to a display device, such as a SLM, optionally via a driver chip. The control signals by which this process is controlled are supplied from one or more controller units; these control signals preferably ensure that one or more holographic sub-frames are produced and sent to the SLM per video frame period. In an embodiment, the control signals transmitted from the controller to both the input and output buffers are read/write select signals, whilst the signals between the controller and the hardware block comprise timing, initialisation and flow-control information.

FIG. 4 shows a set of procedures which may be implemented in either hardware or software to generate one or more holographic sub-frames for each image frame. Preferably one image frame, I_{xy}, is supplied one or more times per video frame period as an input, and each image frame, I_{xy}, is then used to produce one or more holographic sub-frames by means of a set of operations comprising one or more of: a phase modulation stage, a space-frequency transformation stage and a quantisation stage. In embodiments, a set of N sub-frames, where N is greater than or equal to one, is generated per frame period by means of using either one sequential set of the aforementioned operations, or a several sets of such operations acting in parallel on different sub-frames, or a mixture of these two approaches.

The purpose of the phase-modulation block shown in FIG. 4 is to redistribute the energy of the input frame in the spatial-frequency domain, such that improvements in final image quality are obtained after performing later operations. FIG. 5 shows an example of how the energy of a sample image is distributed before and after a phase-modulation stage (multiplication by a random phase matrix) in which a random phase distribution is used. It can be seen that modulating an image by such a phase distribution has the effect of redistributing the energy more evenly throughout the spatial-frequency domain.

The quantisation shown in FIG. 4 has the purpose of taking complex hologram data, which is produced as the output of the preceding space-frequency transform block, and mapping it to a restricted set of values, which correspond to actual phase modulation levels that can be achieved on a target SLM. In an embodiment, the number of quantisation levels is set at two, with an example of such a scheme being a phase modulator producing phase retardations of 0 or π at each pixel. In other embodiments, the number of quantisation levels, corresponding to different phase retardations, may be two or greater. There is no restriction on how the different phase retardations levels are distributed—either a regular distribution, irregular distribution or a mixture of the two may be used. In preferred embodiments the quantiser is configured to quantise real and imaginary components of the holographic sub-frame data to generate a pair of sub-frames for the output buffer, each with two phase-retardation levels. It can be shown that for discretely pixellated fields, the real and imaginary components of the complex holographic sub-frame data are uncorrelated, which is why it is valid to treat the real and imaginary components independently and produce two uncorrelated holographic sub-frames.

FIG. 6 shows modules (hardware and/or software) in which a pair of quantisation elements are arranged in parallel in the system so as to generate a pair of holographic sub-frames from the real and imaginary components of the complex holographic sub-frame data respectively.

There are many different ways in which phase-modulation data, as shown in FIG. 4, may be produced. In an embodiment, pseudo-random binary-phase modulation data is generated by hardware comprising a shift register with feedback and an XOR logic gate. FIG. 7 shows such an embodiment, which also includes hardware to multiply incoming image data by the binary phase data. This hardware comprises means to produce two copies of the incoming data, one of which is multiplied by −1, followed by a multiplexer to select one of the two data copies. The control signal to the multiplexer in this embodiment is the pseudo-random binary-phase modulation data that is produced by the shift-register and associated circuitry, as described previously.

In another embodiment, pre-calculated phase modulation data is stored in a look-up table and a sequence of address values for the look-up table is produced, such that the phase-data read out from the look-up table is random. In this embodiment, it can be shown that a sufficient condition to ensure randomness is that the number of entries in the look-up table, N, is greater than the value, m, by which the address value increases each time, that m is not an integer factor of N, and that the address values ‘wrap around’ to the start of their range when N is exceeded. In a preferred embodiment, N is a power of 2, e.g. 256, such that address wrap around is obtained without any additional circuitry, and m is an odd number such that it is not a factor of N.

FIG. 8 shows hardware to multiply incoming image frame data, I_{xy}, by complex phase values, which are randomly selected from a look-up table, to produce phase-modulated image data, G_{xy}. The hardware comprises a three-input adder with feedback, which produces a sequence of address values for a look-up table containing a set of N data words, each comprising a real and imaginary component. Input image data, I_{xy}, is replicated to form two identical signals, which are multiplied by the real and imaginary components of the selected value from the look-up table. This operation thereby produces the real and imaginary components of the phase-modulated input image data, G_{xy}, respectively. In an embodiment, the third input to the adder, denoted n, is a value representing the current holographic sub-frame. In another embodiment, the third input, n, is omitted. In a further embodiment, m and N are both be chosen to be distinct members of the set of prime numbers, which is a strong condition guaranteeing that the sequence of address values is truly random.

FIG. 9 shows hardware which performs a 2-D FFT on incoming phase-modulated image data, G_{xy} to produce holographic data, gᵤᵥ. In this example, the hardware to perform the 2-D FFT operation comprises a 1-D FFT block, a memory element for storing intermediate row or column results, and a feedback path from the output of the memory to one input of a multiplexer. The other input of this multiplexer is the phase-modulated input image data, G_{xy} and the control signal to the multiplexer is supplied from a controller block, for example as shown in FIG. 3. Such an embodiment represents an area-efficient method of performing a 2-D FFT operation.

The operations described above may be implemented partially or wholly in hardware and/or partially or wholly in software, for example on a general purpose digital signal processor.

### Resolution Enhancement for Holographic Video Projection Using Inter-Pixel Interference

Referring now to FIG. 10 this shows an outline block diagram of a system according to an embodiment of the invention for generating a plurality (N) of subframe holograms for displaying a single image frame using resolution enhancement techniques.

In a 2D holographic video projection system, the theoretical maximum output resolution is normally at most the resolution of the microdisplay, because the replay field (output image) is the Fourier transform of the hologram (shown on the microdisplay), and the Fourier transform is a bijective mapping from [symbol] ^{M×M} to [symbol] ^{M×M}. In practice, however, the usable output resolution is lower for a number of reasons: for example, when an M×M-pixel binary-phase modulator is employed as the microdisplay, the presence of the conjugate image restricts the addressable output resolution to at most M×M/2 points.

It follows that the microdisplay will typically require at least double the number of pixels present in the output, and in practice more. These extra pixels have the effect of:
An increase in microdisplay silicon area, leading to increased cost
An increase in the spatial bandwidth required to drive the display, making drive electronics more complex and costly
An increase in the magnitude of optical aberration in the system due to the increase in the display size, leading to the requirement of more complex (and hence more expensive) optics to avoid serious image artifacts that result from aberration, such as blurring and astigmatism

There would be many advantages if it were possible to use a binary M×M-pixel microdisplay to form output images at a resolution greater than M×M/2.

One possible solution to the problem was described in patent application PCT GB2004 005255, and involves superimposing onto the binary-phase microdisplay a binary phase mask of the same physical size containing 2M×2M points of random but known phases, and taking the phase mask structure into account when calculating the hologram. Such a technique can give an output resolution of 2M×M points, but at the expense of a severe reduction in signal-to-noise (SNR) ratio. Because high SNR is essential for many applications including video, use of such a technique is often not practical.

The inventors have recognised that inter-pixel interference may be exploited to produce increased resolution. Referring to FIG. 12, each point in the output is a copy of the Fourier transform of the hologram aperture. If the aperture is square and the illumination is uniform, this corresponds to a sinc-shaped pixel in the output.

It can be shown (and also seen from the graph) that the main lobe of such a sine function is in fact wider than the inter-pixel distance in the output. Therefore, adjacent pixels will interfere with each other, determined by their relative phases. Ordinarily, this effect is detrimental to the reconstructed image quality, causing random structure between samples that is often referred to rather confusingly as “speckles” in the literature (for example, J. P. Allebach, N. C. Gallagher, and B. Liu, “Aliasing error in digital holography,” Appl. Opt. 15, 2183-2188, 1976). However, it is possible to exploit this effect to our advantage.

Because the eye perceives not the field amplitude F (which has maximum frequency ±M/2) but its intensity |F|² (which can be shown to have maximum frequency ±M), careful manipulation of the phases allows one to influence the pixel values between the sampling grid to create structure at higher spatial frequencies than M/2. For example, while a sequence of output samples [1, 0, 1, 0, 1] results, as expected, in 3 peaks of frequency M/2 (FIG. 13a), a sequence of samples [−1, 1, −1] can be shown to produce 3 peaks of frequency M (FIG. 13b). Takaki and Hojo (“Computer-Generated Holograms to Produce High-Density Intensity Patterns,” Appl. Opt. 38, 2189-2195, 1999) recognized this effect but did not identify a practical way in which it might be used. We describe below how super-resolution can be implemented using an OSPR-type procedure with feedback.

The use of OSPR-with-feedback algorithms can generate OSPR hologram sets of resolution M×M that form high-quality image reproductions at double (in each dimension) the resolution of that of the hologram, i.e. 2M×2M. Allowing for the conjugate image present in a binary phase system, this allows a usable resolution of 2M×M to be achieved.

OSPR-with-feedback algorithms (as described in UK patent application no. 0518912.1 filed 16 Sep. 2005) can generate a set of holograms such that the Nth hologram H_{N} in the set cancels out the cumulative noise produced by holograms H₁ . . . H_{N-1}. This is done by maintaining a dynamic estimate of the reproduction achieved by time-sequencing the holograms H₁ . . . H_{N-1}, and feeding the error forward to the Nth hologram generation stage so it can be cancelled. When the N holograms are time-sequenced, the effect is that only the final hologram in the set contributes to the output noise, resulting in a noise variance that falls as 1/N² (compared with standard OSPR without feedback described in patent application PCT GB2004 005253, where noise variance falls simply as 1/N).

Here we extend this technique by modifying the algorithm so that, in addition to feeding forward the reproduction error present at each of the M×M sampling points (x, y), the errors present between the sampling points after stage N−1, i.e. at (x½, y), (x, y½) and (x½, y½), are also fed forwards and compensated for when calculating the hologram H_{N} in stage N. In embodiments this uses a modified inter-pixel Fourier transform operation to evaluate the frequency components every half-sample, instead of every sample. As an alternative to half-sample evaluation, such a transform can be implemented by, for example, padding each M×M hologram up to 2M×2M by embedding it in a matrix of zeros; in either case and we notate this as F^{2M×2M} [H(x, y)]. Taking the Fourier transform of this padded hologram then produces a 2M×2M field, which can be adjusted for error as desired before taking the inverse Fourier transform to obtain a 2M×2M hologram, which is then bandlimited to form the next M×M hologram in the output OSPR set.

The algorithm uses a combination of incoherent (OSPR-with-feedback) and coherent (phase) optimisation strategies. Coherent optimisation alone using a single hologram per image frame is not sufficient: because the hologram is the frequency spectrum of the image, phase holograms (which de facto have uniform amplitude everywhere) always form images with a uniform (i.e. flat) frequency spectrum, which, for a fixed amplitude target image implies a requirement of effectively random phase in the image pixels. However, as we have discussed above, super-resolution using inter-pixel interference uses exact control over image pixel phase, which is incompatible with the random image pixel phase (flat spectrum) requirement. Additionally using multiple subframe holograms per video frame by means of an OSPR-with-feedback approach allows the exact phase control requirement to be achieved over the temporal integral of a set of subframe holograms (as perceived by the eye), even though the requirement is violated for each individual hologram in the set to allow the flat-spectrum (effectively-random image pixel phase) constraint to be met.

We next describe details of an example super-resolution OSPR-with-feedback procedure:

The variables are as follows:
N is the number of OSPR subframes to generate.
T is the input video frame of resolution 2M×2M.
The M×M-pixel holograms H₁ . . . H_{N} produced at the end of each stage form the output OSPR hologram set.
At each stage of the algorithm, φ(x, y) is re-initialised to a 2M×2M array of uniformly-distributed random phases. Q iterations of a coherent optimisation sub-algorithm are employed to adjust these phases towards an error minimum.
F(x, y) holds a dynamically-updated 2M×2M-pixel reconstruction of the effect of the hologram subframes calculated so far.
γ is the desired display output gamma (2.2 corresponds roughly to a standard CRT).

We next make the following definitions:

| | | Input X | Output Y | |
|---|---|---|---|---|
| Operator | Description | size | size | Definition |
| F | Fourier transform | 2M × 2M | 2M × 2M | $Y ( u , v ) = {\sum }_{x = - M + 1}^{M} {\sum }_{y = - M + 1}^{M} {e}^{- 2 π j ( \frac{ux + vy}{2 M} )}$ |
| F⁻¹ | Inverse Fourier transform | 2M × 2M | 2M × 2M | $Y ( u , v ) = {\sum }_{x = - M + 1}^{M} {\sum }_{y = - M + 1}^{M} {e}^{2 π j ( \frac{ux + vy}{2 M} )}$ |
| F^{2M×2M} | Inter-pixel Fourier transform | M × M | 2M × 2M | $Y ( u , v ) = {\sum }_{x = - \frac{M}{2} + 1}^{\frac{M}{2}} {\sum }_{y = - \frac{M}{2} + 1}^{\frac{M}{2}} {e}^{- 2 π j ( \frac{ux + vy}{2 M} )}$ |

The skilled person will recognise that the modified (inter-pixel) Fourier transform effectively evaluates a Fourier (or inverse Fourier) transform at intermediate image points ie.

$${f}_{0 , 0} \to \begin{matrix}{F}_{0 , 0} & {F}_{0.5 , 0} \\ {F}_{0 , 0.5} & {F}_{0.5 , 0.5}\end{matrix} , {f}_{1 , 0} \to \begin{matrix}{F}_{1 , 0} & {F}_{1.5 , 0} \\ {F}_{1 , 0.5} & {F}_{1.5 , 0.5}\end{matrix} , …$$

In the following, reference may be made to FIG. 11 for an outline of the procedural steps which are described in detail below.

### Preprocessing

T′(x,y):=T(x,y)^{γ/2}

### Stage 1

$$F ( x , y ) := 0$$

$${T}^{″} ( x , y ) := {T}^{′} ( x , y ) \cdot exp \{ jφ ( x , y ) \}$$

$$iterate Q times [ \begin{matrix}\begin{matrix}\begin{matrix}{H}^{″} ( x , y ) := {F}^{- 1} [ {T}^{″} ( x , y ) ] \\ {H}^{′} ( x , y ) := \{ \begin{matrix}1 & if Re [ {H}^{″} ( x , y ) ] > 0 \\ - 1 & otherwise\end{matrix}\end{matrix} \\ {H}_{1} ( x , y ) := {H}^{′} ( - \frac{M}{2} \leq x < \frac{M}{2} , - \frac{M}{2} \leq y < \frac{M}{2} ) \\ X ( x , y ) = {F}^{2 M \times 2 M} [ {H}_{1} ( x , y ) ] \\ {T}^{″} ( x , y ) = {T}^{′} ( x , y ) \cdot exp \{ j∠ X ( x , y ) \}\end{matrix} \\ \end{matrix}$$

### Stage 2

$$F ( x , y ) := F ( x , y ) + {\vert {F}^{2 M \times 2 M} [ {H}_{1} ( x , y ) ] \vert}^{2}$$

$$α := \frac{{\sum }_{x , y} {{T}^{′} ( x , y )}^{4}}{{\sum }_{x , y} F ( x , y ) \cdot {{T}^{′} ( x , y )}^{2}}$$

$${T}^{″} ( x , y ) := \{ \begin{matrix}\sqrt{2 {{T}^{′} ( x , y )}^{2} - α F} \cdot exp \{ jφ ( x , y ) \} & if 2 {{T}^{′} ( x , y )}^{2} > α F \\ 0 & otherwise\end{matrix} \\ iterate Q times [ \begin{matrix}{H}^{″} ( x , y ) := {F}^{- 1} [ {T}^{″} ( x , y ) ] \\ {H}^{′} ( x , y ) := \{ \begin{matrix}1 & if Re [ {H}^{″} ( x , y ) ] > 0 \\ - 1 & otherwise\end{matrix} \\ {H}_{2} ( x , y ) := {H}^{′} ( - \frac{M}{2} \leq x < \frac{M}{2} , - \frac{M}{2} \leq y < \frac{M}{2} ) \\ X ( x , y ) = {F}^{2 M \times 2 M} [ {H}_{2} ( x , y ) ] \\ {T}^{″} ( x , y ) = {T}^{′} ( x , y ) \cdot exp \{ j∠ X ( x , y ) \} \\ \end{matrix}$$

Note that in the above F(x,y) is different to the transform or inverse transform F (which has a superscript).

### Stage N

$$\begin{matrix}F ( x , y ) := F ( x , y ) + {\vert {F}^{2 M \times 2 M} [ {H}_{N - 1} ( x , y ) ] \vert}^{2} & \begin{matrix}update dynamic \\ output estimate\end{matrix} \\ \begin{matrix}α := \frac{( N - 1 ) {\sum }_{x , y} {{T}^{′} ( x , y )}^{4}}{{\sum }_{x , y} F ( x , y ) \cdot {{T}^{′} ( x , y )}^{2}} \\ {T}^{″} ( x , y ) := \{ \begin{matrix}\sqrt{N \cdot {{T}^{′} ( x , y )}^{2} - α F} \cdot exp \{ jφ ( x , y ) \} & if N \cdot {{T}^{′} ( x , y )}^{2} > α F \\ 0 & otherwise\end{matrix}\end{matrix} \} & \begin{matrix}\begin{matrix}calculate 2 M \times 2 M \\ noise compensation\end{matrix} \\ target\end{matrix} \\ iterate Q times [ \begin{matrix}{H}^{″} ( x , y ) := {F}^{- 1} [ {T}^{″} ( x , y ) ] \\ {H}^{′} ( x , y ) := \{ \begin{matrix}1 & if Re [ {H}^{″} ( x , y ) ] > 0 \\ - 1 & otherwise\end{matrix} \\ {H}_{N} ( x , y ) := {H}^{′} ( - \frac{M}{2} \leq x < \frac{M}{2} , - \frac{M}{2} \leq y < \frac{M}{2} ) \\ X ( x , y ) = {F}^{2 M \times 2 M} [ {H}_{N} ( x , y ) ] \\ {T}^{″} ( x , y ) = {T}^{′} ( x , y ) \cdot exp \{ j∠ X ( x , y ) \} \\ \end{matrix} & \begin{matrix}\begin{matrix}\begin{matrix}calculate \\ M \times M \text{-} bandlimited\end{matrix} \\ binary hologram\end{matrix} \\ {H}_{N} ( other \\ approaches may \\ be used )\end{matrix}\end{matrix}$$

Referring to FIGS. 14a and 14b, these show a detailed block diagram of a system for generating a plurality (N) of subframe holograms for displaying a resolution-enhanced image according to the above procedure. In the Figures the operations described above are associated with arrows and the resulting data (typically a two dimensional matrix) by blocks in which [symbol] denotes, [symbol] complex valued data, and {−1,1} quantized (here binarised) data. The variables associated with the 2D matrices are shown alongside the blocks, and the dimensions of the matrices are indicated by arrows. Although in the example of FIG. 14a,b the blocks (matrices) are square, the skilled person will understand that rectangular matrices may also be used—in other words the technique is not limited to square image matrices.

We next describe some results of numerical simulations of the procedure.

With the OSPR-with-feedback algorithms described in UK patent application no. 0518912.1, noise variance falls as 1/N². In the above described super-resolution procedure (2M×2M input image, M×M output hologram), we would expect the same rate of decrease of noise variance. However we would also expect the noise variance value for each N to be greater than the corresponding noise variance in the case of conventional OSPR-with-feedback (M×M input image, M×M output hologram). This is because we are controlling a greater number of parameters in the output field without increasing the number of degrees of freedom in the hologram, and this information loss would be expected to manifest itself as increased output noise in each of the controlled pixels.

To provide a quantitative comparison, we look at the variation with N of a standard deviation over mean statistic (effectively the square root of noise variance) for:
A 128×128-pixel hologram set to generate a 128×128-point field containing a 60×60-pixel uniform square using standard OSPR-with-feedback
A 128×128-pixel hologram set to generate a 256×256-point field containing a 120×120-pixel uniform square, using super-resolution OSPR-with-feedback.

The results obtained through numerical simulation are shown in FIG. 15a. FIG. 15b shows the variation of the reciprocal of the standard deviation over mean statistic, which corresponds roughly to the number of unique grey levels achievable. Linear variation with N shows that noise variance in both cases falls as 1/N².

To show the quality of results achievable with this approach, a 768×384 input image was chosen and embedded in a 1024×1024 frame. Holograms were then generated as follows:
One 512×512 OSPR hologram set, generated using conventional OSPR-with-feedback, to form a downsampled (384×192) version of the target 768×384 image
One 512×512 OSPR hologram set, generated using super-resolution OSPR-with-feedback to form the target 768×384 image

A section of the output in each case is shown in FIGS. 16a and 16b. Interestingly, although FIG. 15b suggests that noise variance with the super-resolution technique is greater than with our previously described OSPR-with-feedback technique (the signal-to-noise ratio or number of usable grey levels is less)—probably because the number of degrees of freedom is reduced, the perceived noise in the image is less with the super-resolution technique—probably because of the effect of the increased effective resolution combined with the eye's response to resolution as compared with noise variance.

Applications for the above described methods and systems include, but are not limited to the following: Mobile phone; PDA; Laptop; Digital camera; Digital video camera; Games console; In-car cinema; Personal navigation systems (In-car or wristwatch GPS); Watch; Personal media player (e.g. MP3 player, personal video player); Dashboard mounted display; Laser light show box; Personal video projector (the “video iPod” idea); Advertising and signage systems; Computer (including desktop); Remote control units; desktop computers, televisions, home multimedia entertainment devices and so forth.

The skilled person will understand that embodiments of the invention may be implemented entirely in hardware, entirely in software, or using a combination of the two.

No doubt many effective alternatives will occur to the skilled person. It will be understood that the invention is not limited to the described embodiments and encompasses modifications apparent to those skilled in the art lying within the spirit and scope of the claims appended hereto.

1. A method of generating data for displaying an image defined by a plurality of holographically generated subframes for display sequentially in time to give the impression of said image, the method comprising:
receiving data for said image for display;
determining holographic data for a said subframe from target image data at a first spatial resolution derived from said received data;
converting said holographic data to image subframe data for display to generate a said holographic subframe, said image subframe data having a second spatial resolution lower than said first spatial resolution;
generating reconstructed image data at said first spatial resolution from said image subframe data, said reconstructed image data representing said displayed holographic subframe;
adjusting said target image data using said reconstructed image data; and
determining holographic data and image subframe data for a subsequent said subframe using said adjusted image data.

2. A method as claimed in claim 1, wherein said target image data comprises target phase image data and target amplitude image data, and wherein said holographic data determining includes adjusting said target phase image data responsive to said image subframe data for said holographic subframe generated from said holographic data.

3. A method as claimed in claim 2 further comprising randomising said target phase image data prior to said holographic data determining.

4. A method as claimed in claim 1, wherein said converting comprises phase quantising said holographic data.

5. A method as claimed in claim 1 wherein said converting of said holographic data to said image subframe data comprises band limiting said holographic data.

6. A method as claimed in claim 1 wherein said generating of said reconstructed image data comprises performing a transformation from a frequency domain to a spatial domain, said transformation providing an increase in resolution from said second to said first resolution.

7. A method as claimed in claim 6 wherein said generating of said reconstructed image data further comprises converting an output of aid transformation into magnitude value data to determine said reconstructed image data.

8. A method of generating data for displaying an image using a plurality of holographically generated temporal image subframes, the method comprising:
receiving data for said image to be displayed and determining target image data from said received data;
performing a space-frequency transform at a first resolution on said target image data to generate data for a said image subframe; and
reducing said first resolution to generate data for displaying a said subframe.

9. A method as claimed in claim 8 wherein said target image data includes phase data, and wherein the method further comprises adjusting a phase of said target image data for a said subframe to compensate for phase-related noise in said subframe.

10. A method as claimed in claim 8 wherein said target image data includes phase data, and wherein the method further comprises adjusting said phase data of said target image data for a subframe to compensate for phase-related noise in a previous subframe.

11. A method as claimed in claim 10 wherein said phase data adjusting to compensate for phase-related noise in a previous subframe comprises performing a frequency-space transform of said data for an image subframe which includes an increase in resolution to said first resolution.

12. A method of generating data for displaying an image defined by displayed image data using a plurality of holographically generated temporal subframes, said temporal subframes being displayed sequentially in time such that they are perceived as a single noise-reduced image, the method comprising generating from said displayed image data holographic data for each subframe of said set of subframes such that successive replay of holograms defined by said holographic data for said subframes gives the appearance of said image, a said subframe having a reduced resolution compared to a resolution of said image data, and wherein the method further comprises, when generating said holographic data for a said subframe, compensating for said resolution reduction arising from one or more previous subframes of said sequence of holographically generated subframes.

13. A carrier carrying processor control code to, when running, implement the method of claim 1.

14. A system for generating data for displaying an image defined by a plurality of holographically generated subframes for display sequentially in time to give the impression of said image, the system comprising:
an input to receive data for said image for display;
working memory;
a holographic subframe output;
program memory storing processor control code; and
a processor coupled to said program memory, data memory input, and output, to load and implement said processor control code, said code comprising code for controlling the processor to:
determine holographic data for a said subframe from target image data at a first spatial resolution derived from said received data;
convert said holographic data to image subframe data for display to generate a said holographic subframe, said image subframe data having a second spatial resolution lower than said first spatial resolution;
generate reconstructed image data at said first spatial resolution from said image subframe data, said reconstructed image data representing said displayed holographic subframe;
adjust said target image data using said reconstructed image data; and
determine holographic data and image subframe data for a subsequent said subframe using said adjusted image data.

15. A system for generating data for displaying an image using a plurality of holographically generated temporal image subframes, the system comprising:
an input to receive data for said image to be displayed;
working memory;
a holographic subframe output;
program memory storing processor control code; and
a processor coupled to said program memory, data memory input, and output, to load and implement said processor control code, said code comprising code for controlling the processor to:
determine target image data from said received data;
perform a space-frequency transform at a first resolution on said target image data to generate data for a said image subframe; and
reduce said first resolution to generate data for displaying a said subframe.

16. A system for displaying an image defined by displayed image data using a plurality of holographically generated temporal subframes, said temporal subframes being displayed sequentially in time such that they are perceived as a single-noise reduced image, the system comprising:
an input for said displayed image data;
working memory for storing said displayed image data and said holographic subframe data;
a holographic subframe data output;
program memory storing processor control code; and
a processor coupled to said memory, data memory, input, and output, to load and implement said processor control code, said code comprising code for controlling the processor to:
generate from said displayed image data holographic data for each subframe of said set of subframes such that successive replay of holograms defined by said holographic data for said subframes gives the appearance of said image, a said subframe having a reduced resolution compared to a resolution of said image data; and, when generating said holographic data for a said subframe,
compensate for said resolution reduction arising from one or more previous subframes of said sequence of holographically generated subframes.

17. A carrier carrying processor control code to, when running, implement the method of claim 8.

18. A carrier carrying processor control code to, when running, implement the method of claim 12.
